(19) United States
(12) Patent Application Publication
(10) Pub. No.: US 2024/0063651 A1
(43) Pub. Date: Feb. 22, 2024

(54) CONTROLLING ELECTRICAL POWER FLOWING FROM A BATTERY

(71) Applicant: Microsoft Technology Licensing, LLC, Redmond, WA (US)

(72) Inventor: Donghwi KIM, Kirkland, WA (US)

(73) Assignee: Microsoft Technology Licensing, LLC, Redmond, WA (US)

(21) Appl. No.: 17/931,681

(22) Filed: Sep. 13, 2022

Related U.S. Application Data
(60) Provisional application No. 63/371,624, filed on Aug. 16, 2022.

(51) Int. Cl. H02J 7/00

(52) U.S. Cl. CPC H02J 7/007182; H02J 7/0048

(57) ABSTRACT

Examples are disclosed that relate to controlling power from a battery on a computing device. One example provides a power management system for a computing device having a battery powering first and second processing units. The power management system comprises a controller. The controller is configured to receive a RSOC of the battery and compute first and second current limit values based at least on the RSOC. The power management system further comprises a first power channel including a first first-stage regulator having a current limiter. The current limiter is configured to dynamically limit, to the first current value, a first current flowing from the battery to the first processing unit. The power management system further comprises a second power channel including a second first-stage regulator having a current limiter configured to dynamically limit, to the second current limit value, a second current flowing from the battery.

### CROSS REFERENCE TO RELATED APPLICATIONS

This application claims priority to U.S. Provisional Patent Application No. 63/371,624, entitled CONTROLLING ELECTRICAL POWER FLOWING FROM A BATTERY, filed Aug. 16, 2022, the entirety of which is hereby incorporated herein by reference for all purposes.

### BACKGROUND

Batteries for computing devices may be selected based on various factors. Battery dimensions may impact a size of the computing device. A battery capacity may impact battery life or a runtime between charging of the battery. A total peak power envelope of the battery may impact an available power that the battery provides to the computing device. Further, a relative state-of-charge (RSOC) of the battery may decrease over a lifetime of the battery. A decrease in the RSOC may decrease the available peak power envelope of the battery.

### SUMMARY

Examples are disclosed that relate to controlling an electrical power flowing from a battery on a computing device. One example provides a power management system for a computing device having a battery configured to power a first processing unit and a second processing unit. The power management system comprises a controller. The controller is configured to receive a RSOC of the battery. The controller further is configured to compute a first current limit value and a second current limit value based at least on the RSOC. The power management system further comprises a first power channel including a first first-stage regulator having a current limiter. The current limiter is configured to dynamically limit, to the first current value, a first current flowing from the battery to the first processing unit. The power management system further comprises a second power channel including a second first-stage regulator having a current limiter. The current limiter is configured to dynamically limit, to the second current limit value, a second current flowing from the battery to the second processing unit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an example computing device having a power management system.

FIG. 2 schematically shows an example timing diagram of a first-stage output voltage.

FIG. 3 schematically shows an example timing diagram of a battery output voltage for a battery of the computing device of FIG. 1.

FIG. 4 schematically shows an example timing diagram illustrating a voltage droop count on a battery output voltage of the computing device of FIG. 1.

FIG. 5 schematically shows an example timing diagram illustrating an exponentially weighted moving average of a battery output voltage of the computing device of FIG. 1.

FIGS. 6A and 6B illustrate a flow diagram of an example method for controlling an electrical power flowing from a battery on a computing device.

FIG. 7 shows a block diagram of an example computing system that can be used as the computing device in FIG. 1.

### DETAILED DESCRIPTION

As previously mentioned, batteries for computing devices may be selected on various factors. One factor is battery capacity. A larger battery capacity may power a computing device for a longer period of time before being recharged than a smaller battery capacity. For example, with a given physical volume, a computing device having a 2S battery, with more watt-hours, instead of a 3S battery, with less watt-hours, may power a computing device for a longer period of time before being recharged. However, an available total peak power envelope across different RSOC values of the battery may decrease over a lifetime of the battery and thus, a peak power envelope of the battery may provide less available power as the battery ages. In some scenarios, a peak power demand of the computing device may rise over the available power. For example, processing units on the computing device may increase the peak power demand while processing heavy tasks. Examples of such heavy processing tasks include gaming, graphics, and/or heavy multi-tasking scenarios. Increasing the peak power demand over the available power may result in a brown-out scenario in the computing device. The brown-out scenario may shut down the computing device catastrophically and thus may damage the processing units.

One possible solution is to monitor battery output voltage and use a processor-hot assertion to help limit the peak power demand of the processing units. However, the processor-hot assertion may perform hard throttling of the processing units. For example, the hard throttling may include significantly lowering a switching frequency of the processing unit. Significantly lowering the switching frequency of the processing units may drastically impact a performance of the computing device. As an example, significantly lowering the switching frequency may impact a frames per second of a graphics program and as such, may be undesirable for a user of the computing device. Such a conservative brown-out suppression may cause a performance degradation of the processing units and functionality of the computing device. Further, as each processing unit may increase the power demand at different times, predicting a peak power demand at the battery of the computing device may be difficult.

Accordingly, examples are disclosed that relate to a power management system for a computing device having a battery configured to power a processing unit. The power management system comprises a controller and a power channel that controls a power flowing from the battery to the processing unit. The controller is configured to receive a RSOC of the battery and compute a current limit value based at least on the RSOC. The power channel includes a first-stage regulator including a current limiter configured to dynamically limit, to the current limit value, a current flowing from the battery to the processing unit and resulting in a voltage droop on a first-stage output voltage.

The power channel further includes a second-stage regulator configured to detect the voltage droop on the first-stage output voltage. The second-stage regulator is configured to lower a second-stage output voltage by an amount in response to the voltage droop on the first-stage output voltage meeting a droop threshold condition. The second-stage output voltage is configured to power the processing unit. When the second-stage output voltage is lowered, a power demand of the processing unit may be lowered. In such a manner, the power channel may help to protect the computing device from a brown-out scenario while impacting a performance of the processing unit less than a processor-hot assertion. In some examples, the power management system can further include a second power channel including a first-stage regulator and a second stage-regulator. A second-stage output voltage of the second power channel is configured to power a second processing unit. Such a configuration may help to reduce a power demand of the second processing unit. In some examples, the controller further is configured to monitor a battery output voltage. The controller is configured to adjust a performance parameter of a processing unit in response to the battery output voltage meeting a battery droop threshold condition. As used herein the term “processing unit” may generally refer to a processor core, a group of processor cores, a central processing unit (CPU), a graphics processing unit (GPU), a neural processing unit (NPU), a communication processor (e.g., 5G baseband processor, wireless fidelity (WIFI) processor, etc.), and/or a memory controller.

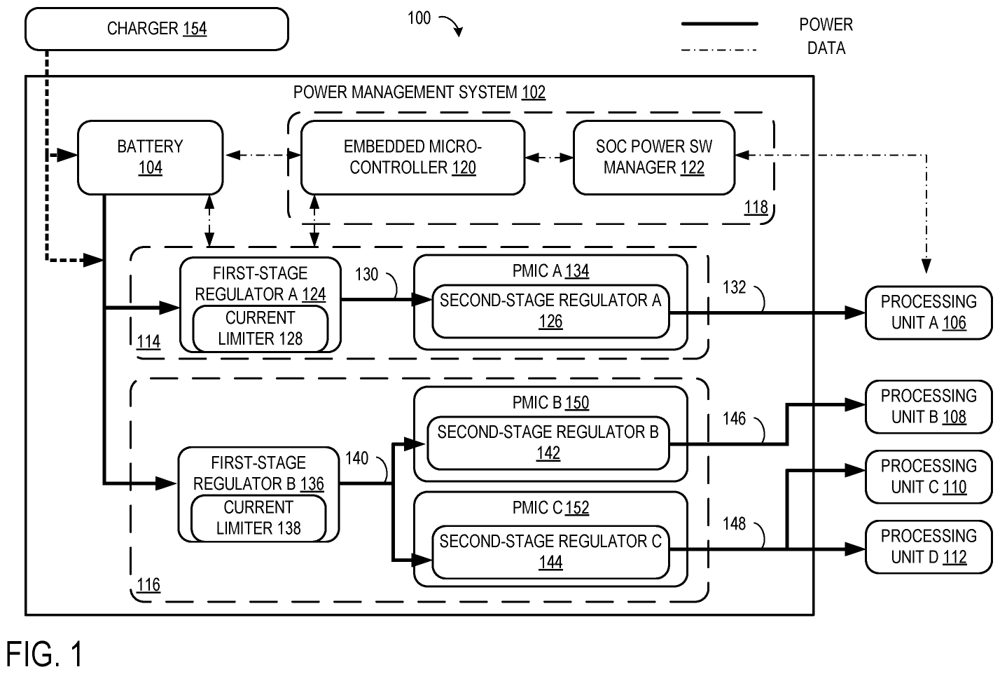

FIG. 1 shows an example computing device 100 that uses a power management system 102 for controlling electrical power flowing from a battery 104. Battery 104 powers a first processing unit 106, a second processing unit 108, a third processing unit 110, and a fourth processing unit 112 using power management system 102. In the depicted example, power from battery 104 to first processing unit 106 flows through a first power channel 114. Further, power from battery 104 to second processing unit 108, third processing unit 110, and fourth processing unit flows through a second power channel 116.

Power management system 102 includes a controller 118. The depicted controller 118 includes an embedded micro-controller 120 and a system-on-a-chip (SoC) power software (SW) manager 122. Embedded micro-controller 120 is configured to receive a RSOC of battery 104. Embedded micro-controller further is configured to compute a first current limit value and a second current limit value based at least on the RSOC. In some examples, embedded micro-controller 120 may dynamically recompute the first current limit value and the second current limit value based on various factors such as aging, battery impedance, power delivery path impedance from the battery to a printed circuit board, etc. In such a manner, the first current limit value and the second current limit value may be adjusted based at least on a change in RSOC. As a specific example, a total battery current of 80 A (amperes) may be available at a first RSOC and embedded micro-controller 120 computes a first current limit value of 50 A and a second current limit value of 30 A. Next, when a total battery current of 60 A may be available at a second RSOC, embedded micro-controller 120 recomputes the first current limit value to a value of 10 A and the second current limit value to a value of 50 A. In such a manner, a higher priority processing unit may receive a larger portion of the total battery current at the second RSOC than a lower priority processing unit. Further, in some examples, computing the first current limit value and the second current limit value may be based at least on a battery impedance table at RSOC and a battery output voltage. In other examples, the first current limit value and the second current limit value may be determined in any other suitable manner. SoC power SW manager 122 monitors a battery output voltage. SoC power SW manager 122 may adjust one or more performance parameters of one or more of first processing unit 106, second processing unit 108, third processing unit 110, and fourth processing unit 112 in response to the battery output voltage meeting a battery droop threshold condition, as discussed below. Examples of the performance parameters include a switching frequency, a total power capping, a core power capping, a burst mode, and any other suitable processing unit performance parameter. Adjusting such performance parameters may help to lower a power demand of a processing unit. In other examples, controller 118 may alternately or additionally include other components not illustrated.

First power channel 114 controls power from battery 104 to first processing unit 106 using a first first-stage regulator 124 and a first second-stage regulator 126. First first-stage regulator 124 and first second-stage regulator 126 may include any suitable type of voltage regulators configured to perform voltage regulation. Examples of suitable voltage regulators include series voltage regulators, shunt voltage regulators, low-drop-out voltage regulators, and switched-mode power supplies. First first-stage regulator 124 has a first current limiter 128. First current limiter 128 may be incorporated into the voltage regulator or implemented as separate circuitry. First current limiter 128 dynamically limits, to the first current limit value, a first current flowing from battery 104 to first processing unit 106 and resulting in a voltage droop on a first first-stage output voltage 130. Such a configuration may help to reduce a brown-out scenario. Specifically, dynamically limiting the first current may help to reduce the power demand of first processing unit 106 during a peak power demand associated with the first current being above the first current limit value. In some examples, first first-stage regulator 124 may further include input and/or output filtering. Such a configuration may help to smooth power spikes at battery 104.

First second-stage regulator 126 performs voltage regulation on a first second-stage output voltage 132. Further, first second-stage regulator 126 monitors first first-stage output voltage 130 for a voltage droop. First second-stage regulator 126 may use any suitable droop detection circuitry, such as a voltage comparator for example. Such a configuration may help to reduce a response time of first second-stage regulator 126. The droop detection circuitry may be integrated into a voltage regulator of first second-stage regulator 126, separate circuitry within first second-stage regulator 126, or implemented using software. First second-stage regulator 126 is configured to lower first second-stage output voltage 132 by an amount for a duration of time and then raise first second-stage output voltage 132 by the amount after the duration of time in response to the voltage droop on first first-stage output voltage 130 meeting a droop threshold condition. In some examples, the droop threshold condition may include first first-stage output voltage 130 drooping below a threshold voltage value. In some such examples, the threshold voltage value may be configurable by using registers in first second-stage regulator 126. In other examples, another suitable droop threshold condition may be used. Further, first second-stage output voltage 132 powers first processing unit 106. In such a manner, first power channel 114 may help to decrease a power demand of first processing unit 106 while impacting a performance of first processing unit 106 less than a processor-hot assertion. As a specific example, lowering first second-stage output voltage 132 may result in lowering a frequency of first processing unit 106 and reduce a power demand of first processing unit 106. Using first first-stage regulator 124 and first second-stage regulator 126 may help to provide voltage isolation and/or help to smooth voltage changes at battery 104. Similarly, raising first second-stage output voltage 132 by the amount after the duration of time may correspondingly raise the frequency of first processing unit 106 after the duration of time. In such a manner, an impact to a performance of first processing unit 106 may be reduced compared to using a processor-hot assertion to reduce the power demand of first processing unit 106. In some examples, first second-stage regulator 126 is further configured to lower first second-stage output voltage 132 in response to the voltage droop on the first first-stage output voltage 130 meeting a second droop threshold condition. More specifically, the second droop threshold condition may indicate a larger droop on first first-stage output voltage 130 than the first droop threshold condition. As such, the second amount may be larger than the first amount and may help to further reduce the power demand of first processing unit 106. In some examples, first second-stage regulator 126 may include input and/or output filtering. Such a configuration may help to smooth power spikes at battery 104. In the depicted example, first second-stage regulator 126 is implemented in a first power management integrated-circuit (PMIC) 134. In other examples, first second-stage regulator may be implemented in any other suitable circuitry.

Power management system 102 further includes a second power channel 116. In a similar manner, second power channel includes a second first-stage regulator 136 having a second current limiter 138 configured to dynamically limit, to the second current limit value, a second current flowing from battery 104 to second processing unit 108, third processing unit 110, and fourth processing unit 112 in response to the second current being over the second current limit value. Dynamically limiting the second current may result in a voltage droop on a second first-stage output voltage 140. A second second-stage regulator 142 and a third second-stage regulator 144 monitor second first-stage output voltage 140 for a voltage droop. Second second-stage regulator 142 is configured to lower a second second-stage output voltage 146 by an amount in response to second first-stage output voltage 140 meeting the first droop threshold condition. Second second-stage output voltage 146 powers second processing unit 108. In such a manner, a power demand of second processing unit 108 is reduced in response to the second current being over the second current limit value. Further, the power demand of second processing unit 108 may not be reduced in response to the second current being under the second current limit value. Similarly, third second-stage regulator 144 is configured to lower a third second-stage output voltage 148 in response to second first-stage output voltage 140 meeting the droop threshold condition. In contrast, third second-stage output voltage 148 powers third processing unit 110 and fourth processing unit 112. In the depicted example, second second-stage regulator 142 is implemented in a second PMIC 150 and third second-stage regulator 144 is implemented in a third PMIC 152. In other examples, second and third second-stage regulators 142, 144 may be implemented in any suitable manner. In other examples, first second-stage regulator 126, second second-stage regulator 142, and/or third second-stage regulator 144 may monitor a respective first-stage output voltage for different threshold conditions.

Computing device 100 further includes a charger 154. When computing device 100 is connected to charger 154, charger 154 may provide sufficient available power to computing device 100 to handle the peak power demand of first processing unit 106, second processing unit 108, third processing unit 110, and fourth processing unit 112. In other examples, computing device 100 may include one, two, or three processing units. As such, power management system 102 may omit second power channel 116 and/or third second-stage regulator 144.

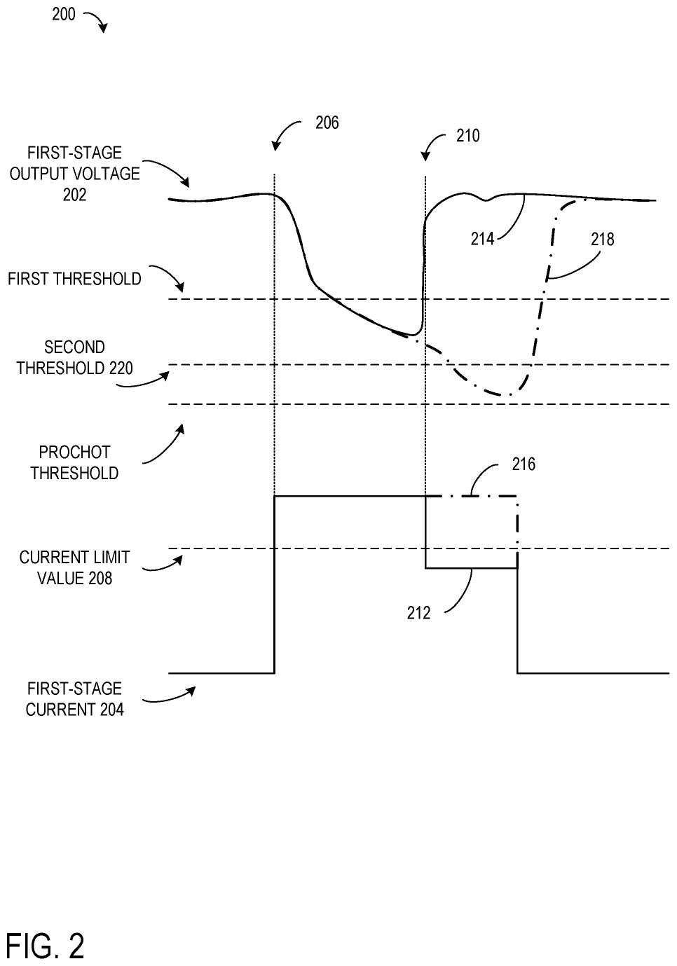

As previously mentioned, a first-stage regulator is configured to dynamically limit a current flowing from a battery and results in a voltage droop on a first-stage output voltage. FIG. 2 shows an example timing diagram 200 of such a voltage droop on a first-stage output voltage 202. In the depicted example, a first-stage current 204 is a portion of the current that flows from the battery and through a first-stage regulator, such as first first-stage regulator 124 for example. At a first time 206, first-stage current 204 peaks above a current limit value 208 and as shown, a first-stage output voltage 202 starts to droop. At a second time 210, first-stage current 204 is limited to a current value 212 below current limit value 208. The difference between first time 206 and second time 210 may be based at least on a current spike deglitching time. In other examples, first-stage current 204 may be limited to current limit value 208. As shown, at second time 210, first-stage output voltage 202 starts to rise to a nominal voltage, as indicated at 214. In contrast, when first-stage current 204 is not limited, as indicated at 216, first-stage output voltage 202 continues to droop as indicated by a first-stage droop voltage 218. In the depicted example, first-stage droop voltage 218 reaches below a second threshold 220. In some examples, an impact to a performance of a downstream processing unit may be associated with second threshold 220. Thus, limiting first-stage current 204 may help to reduce a performance impact of a processing unit associated with threshold conditions, such as second threshold 220.

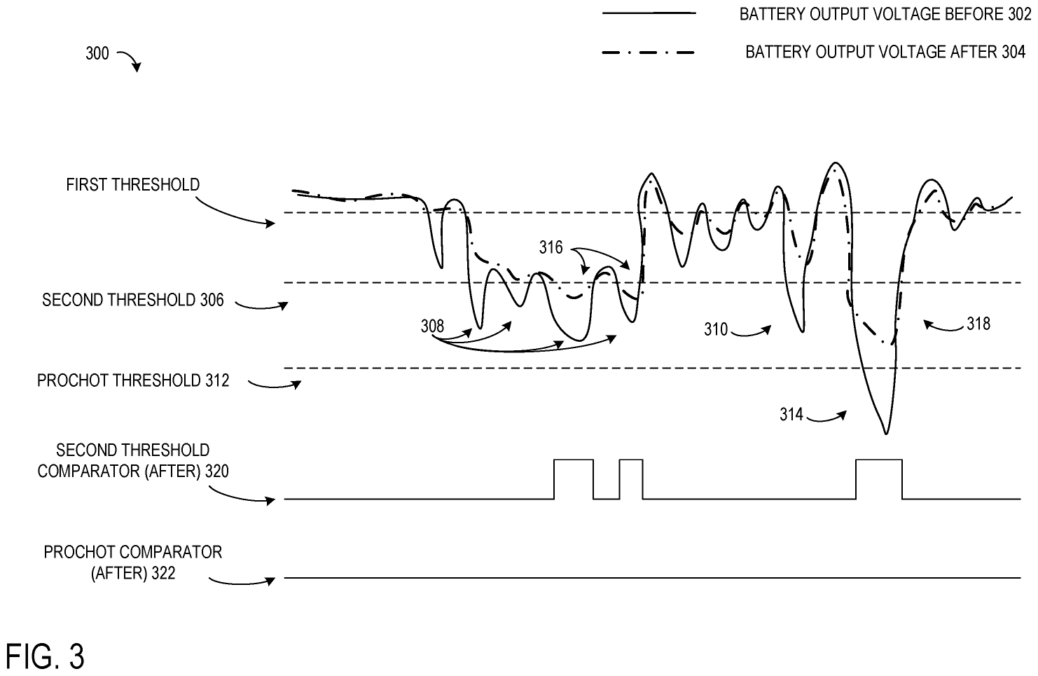

As previously mentioned, a power management system may be used for controlling electrical power flowing from a battery. FIG. 3 illustrates an example timing diagram 300 of a first battery output voltage 302 before using a power management system and a second battery output voltage 304 after using the power management system. Timing diagram 300 may be used by power management system 102, for example. As shown, first battery output voltage 302 before using the power management system reaches a second threshold 306 as indicated at 308 and 310. Further, first battery output voltage 302 reaches a processor-hot (prochot) threshold 312, as indicated at 314. As previously mentioned, processor-hot threshold 312 may perform hard throttling of a down-stream processing unit. Such hard throttling may significantly impact a performance of the down-stream processing unit. In contrast, second battery output voltage 304 after using the power management system droops below second threshold 306 for a shorter duration, as indicated at 316 and 318, and along second threshold comparator 320. As shown, second battery output voltage 304 droops less than first battery output voltage 302. Further, second battery output voltage 304 does not droop below processor-hot threshold 312 as indicated along processor-hot comparator 322. In such a manner, the power management system may help to reduce a number of processor-hot assertions. Timing diagram 300 is intended to be illustrative and any other suitable timing diagrams may be used.

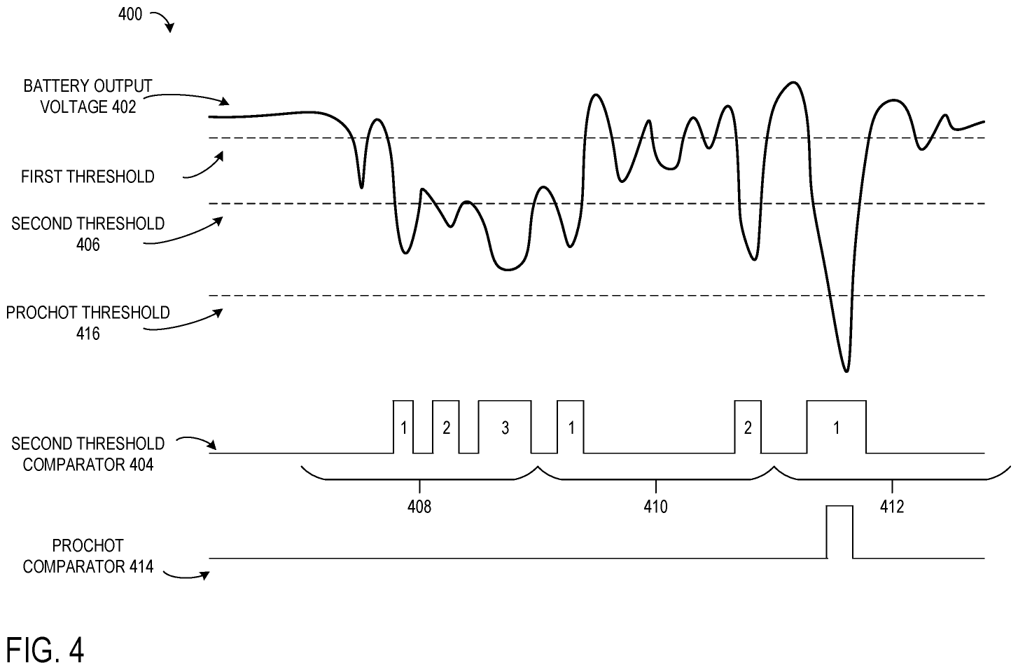

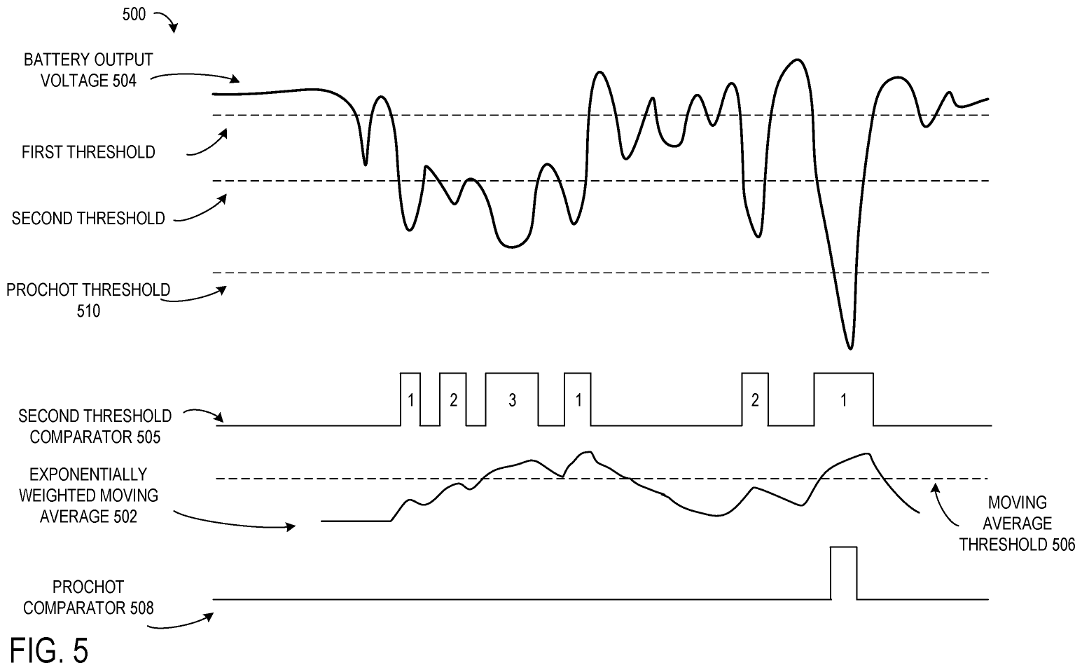

As previously mentioned, a controller of a power management system may be configured to monitor a battery output voltage and adjust a performance parameter of a processing unit when a battery droop threshold condition is met. FIG. 4 illustrates an example timing diagram 400 of a battery output voltage 402. Timing diagram 400 may be used by any suitable controller of a power management system, such as SoC power SW manager 122 for example. As shown, a second threshold comparator 404 indicates when battery output voltage 402 droops below a second threshold 406. In the depicted example, the controller may count a number of voltage droop events in a time period based at least on second threshold comparator 404. As specific examples, a first time period 408 includes a count number of three. A second time period 410 includes a count number of two. A third time period 412 includes a count number of one. When the count number reaches a count number threshold, a battery droop threshold condition may be met. Further, processor-hot comparator (prochot) 414 indicates when a processor-hot threshold 416 has been met. Timing diagram 400 is intended to be illustrative and any other suitable timing diagram may be used. Additionally or alternatively, the controller of the power management system may determine an exponentially weighted moving average 502 of a battery output voltage 504 as illustrated in FIG. 5. In the depicted example, exponentially weighted moving average 502 is determined from a second threshold comparator 505. In such a manner, exponentially weighted moving average 502 may indicate an average power at the battery over a time period. In other examples, exponentially weighted moving average 502 may be determined in any other suitable manner. When exponentially weighted moving average 502 of second threshold comparator 505 exceeds a moving average threshold 506, the battery droop threshold condition can be determined to be met and a performance parameter of a processing unit may be adjusted. Processor-hot comparator 508 indicates when a processor-hot threshold 510 has been met. FIG. 5 is intended to be illustrative and any other suitable timing diagram may be used. In other examples, the battery droop threshold condition can be determined to be met in another suitable manner.

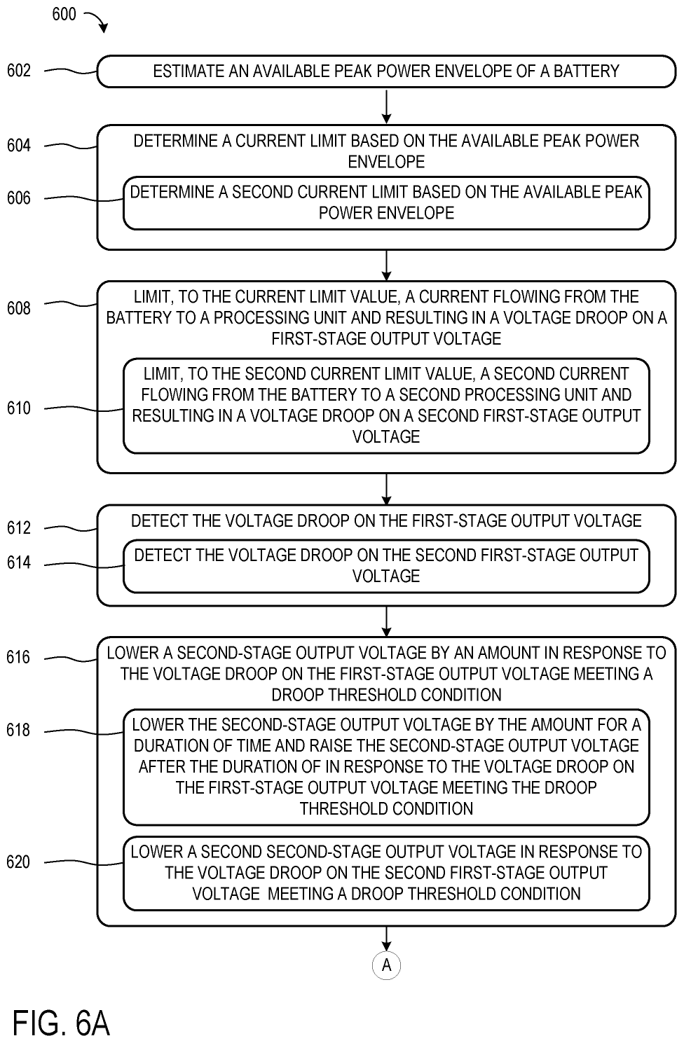

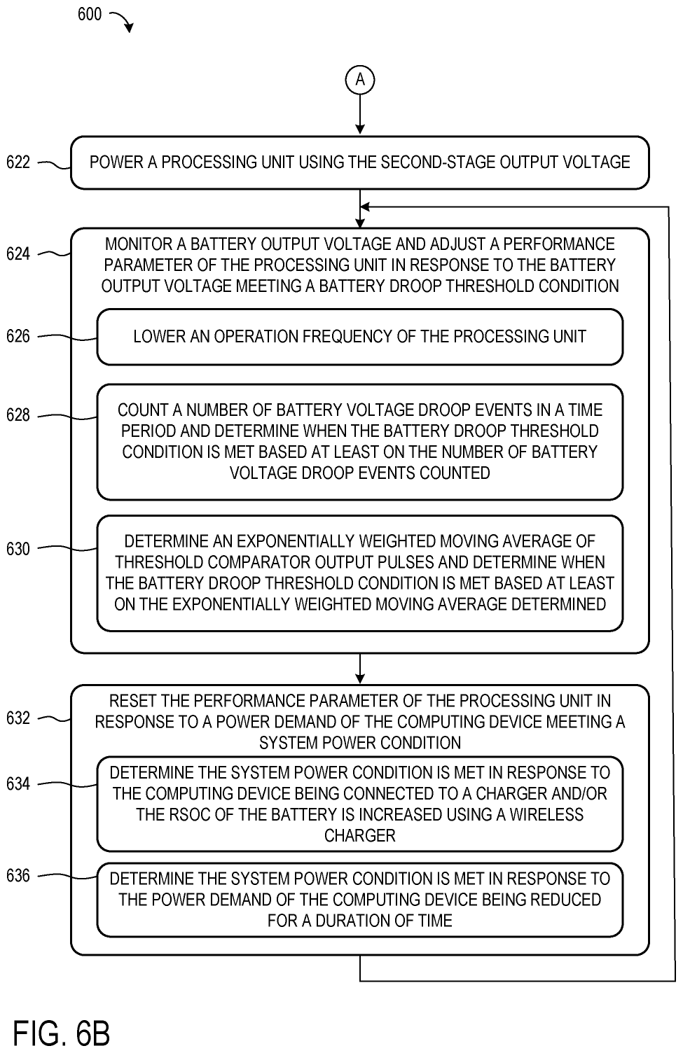

FIGS. 6A and 6B illustrate a flow diagram of an example method 600 for controlling an electrical power flowing from a battery on a computing device. Method 600 may be performed on any suitable computing device having a power management system, such as power management system 102 for example. Method 600 includes, at 602, estimating an available peak power envelope of the battery based at least on a relative state-of-charge (RSOC) of the battery. In some examples, a gas-gauge interface of the battery may provide the RSOC. In other examples, the RSOC may be determined based at least on a battery impedance of the battery. In yet other examples, the RSOC may be determined in any other suitable manner. Continuing, method 600 includes, at 604, determining a current limit value based at least on the available peak power envelope. Method 600 further includes, at 606, determining a second current limit value based at least on the available power peak envelope. The first and second current limit value may be less than the total current of the available peak power envelope. Such a configuration may help to reduce brown-out scenarios on the computing device.

Method 600 includes, at 608, limiting, to the current limit value, a current flowing from the battery to a processing unit using a current limiter of a first-stage regulator and resulting in a voltage droop on a first-stage output voltage. Such a configuration may help to reduce a power demand of the processing unit. Method 600 further includes, at 610, limiting, to the second current limit value, a second current flowing from the battery to a second processing unit using a current limiter of a second first-stage regulator and resulting in a voltage droop on a second first-stage output voltage in response to the second current being over the second current limit value. Such a configuration may help to reduce a power demand of the second processing unit.

Method 600 further includes detecting the voltage droop on the first-stage output voltage using a second-stage regulator at 612, and detecting the voltage droop on the second first-stage output voltage using a second second-stage regulator at 614. Method 600 includes, at 616, lowering a second-stage output voltage by an amount in response to the voltage droop on the first-stage output voltage meeting a droop threshold condition. The amount may be a percentage of the second-stage output voltage, a voltage value, or any other suitable amount. In response to the voltage droop on the first-stage output voltage meeting the droop threshold condition, method 600 includes lowering the second-stage output voltage by the amount for a duration of time and then raising the second-stage output voltage by the amount after the duration of time, as indicated at 618. In such a manner, a power demand of processing unit may be reduced and may help to reduce a performance impact of the processing unit compared to a processor-hot assertion. Continuing, method 600 includes, at 620, lowering a second second-stage output voltage in response to the voltage droop on the second first-stage output voltage meeting the droop threshold condition. Such a configuration may help to reduce a power demand of the second processing unit. Returning, method 600 includes, at 622, powering the processing unit using the second-stage output voltage. In such a manner, the power management system may help to reduce a power demand of the processing unit and while helping to reduce an occurrence of a processor-hot assertion. In other examples, method 600 may omit 606, 610, 614, and/or 620.

In some examples, method 600 may continue, at 624, to include monitoring a battery output voltage, and adjusting a performance parameter of the processing unit in response to the battery output voltage meeting a battery droop threshold condition. Adjusting the performance parameter includes lowering an operational frequency of the processing unit, as indicated at 626. In other examples, other suitable performance parameters may be adjusted. Method 600 further includes, at 628, counting a number of battery voltage droop events in a time period and determining when the battery droop threshold condition is met based at least on the number of battery voltage droop events counted. Alternatively or additionally, method 600 includes, at 630, determining an exponentially weighted moving average of threshold comparator output pulses and determining when the battery droop threshold condition is met based at least on the exponentially weighted moving average determined. In such a manner, the power management system may further control an electrical power flowing from the battery on the computing device and help to reduce an occurrence of the processor-hot assertion.

Continuing, method 600 includes, at 632, resetting the performance parameter of the processing unit in response to a power demand of the computing device meeting a system power condition. In some examples, the power demand may comprise a total system power, an average total system power, or any other suitable power metric. In some examples, resetting the performance parameter may comprise setting the performance parameter to a value before adjusting the performance parameter. In other examples, resetting the performance parameter may comprise setting the performance parameter to an original value. Returning, method 600 includes, at 634, determining the system power condition is met in response to the computing device being connected to a charger and/or the RSOC of the battery is increased using a wireless charger. Such a configuration may help to increase the available peak power envelope of the battery. Further, the increase in the available peak power envelope may help to reduce a duration of time when the processing unit operates using the performance parameter adjusted. Alternatively or additionally, method 600 includes, at 636, determining the system power condition is met in response to the power demand of the computing device being reduced for a duration of time. As a specific example, the switching frequency of the processor may be reduced for around one minute and during the around one minute the power demand of the processing unit may be reduced. In such a configuration, a likelihood of a brown-out scenario on the processing unit is reduced. Further, after the around one minute, the switching frequency may be reset. Such a configuration helps to reduce a performance impact of the processing unit while reducing brown-out conditions compared to a processor-hot assertion. Continuing, method 600 returns to 624. In other examples, method 600 may omit 634 and/or 636.

A power management system for a computing device having a battery configured to power a processing unit as described herein may help to reduce brown-out scenarios while helping to reduce an occurrence of a processor-hot assertion. More specifically, a first-stage regulator and a second-stage regulator of a power channel help to provide a two stage brown-out protection. Further, the power management system may help a peak burst performance of the computing system by monitoring a battery voltage droop and adjusting performance parameters of the processing unit.

In some embodiments, the methods and processes described herein may be tied to a computing system of one or more computing devices. In particular, such methods and processes may be implemented as a computer-application program or service, an application-programming interface (API), a library, and/or other computer-program product.

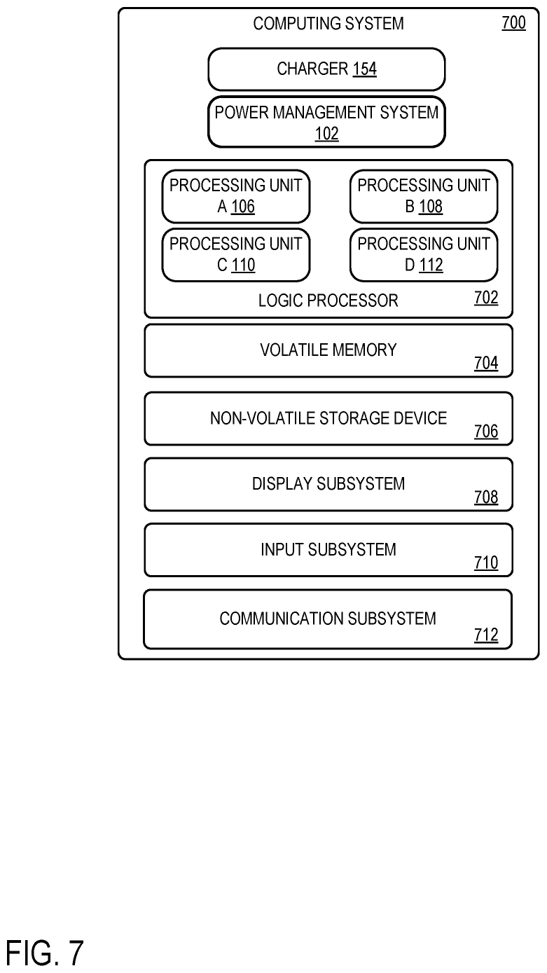

FIG. 7 schematically shows a non-limiting embodiment of a computing system 700 that can enact one or more of the methods and processes described above. Computing system 700 is shown in simplified form. Computing system 700 may embody the computing device 100 described above and illustrated in FIG. 1. Computing system 700 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices. Computing device 100 is an example of computing system 700.

Computing system 700 includes a logic processor 702, volatile memory 704, and a non-volatile storage device 706. Computing system 700 may optionally include a display sub system 708, input sub system 710, communication sub system 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result. First processing unit 106, second processing unit 108, third processing unit 110, and fourth processing unit 112 are examples of logic processor 702, and may be cores of a multi-core processor or processors, for example. Charger 154 and power management system 102 may be configured to supply power not only to the logic processor 702 but also to volatile memory 704, non-volatile storage device 706, display subsystem 708, input subsystem 710, and/or communication subsystem 712.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built-in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Another example provides a power management system for a computing device having a battery configured to power a first processing unit and a second processing unit, comprising a controller configured to receive a relative state-of-charge of the battery, and compute a first current limit value and a second current limit value based at least on the relative state-of-charge, a first power channel including a first first-stage regulator having a current limiter configured to dynamically limit, to the first current limit value, a first current flowing from the battery to the first processing unit, and a second power channel including a second first-stage regulator having a current limiter configured to dynamically limit, to the second current limit value, a second current flowing from the battery to the second processing unit. In some such examples, the first first-stage regulator of the first power channel alternatively or additionally is a first-stage regulator configured to dynamically limit the first current and resulting in a voltage droop on a first-stage output voltage, and the first power channel alternatively or additionally includes a second-stage regulator configured to detect the voltage droop on the first-stage output voltage and lower a second-stage output voltage by an amount in response to the voltage droop meeting a droop threshold condition, the second-stage output voltage configured to power the first processing unit. In some such examples, the second-stage regulator alternatively or additionally is configured to lower the second-stage output voltage by the amount for a duration of time and then raise the second-stage output voltage by the amount after the duration of time in response to the voltage droop on the first-stage output voltage meeting the droop threshold condition. In some such examples, the second-stage regulator alternatively or additionally is implemented in a power management integrated circuit (PMIC). In some such examples, the controller alternatively or additionally is configured to monitor a battery output voltage and adjust a performance parameter of the processing unit in response to the battery output voltage meeting a battery droop threshold condition. In some such examples, the processing unit alternatively or additionally is selected from the group consisting of a processor core, a central processing unit (CPU), a graphics processing unit (GPU), a neural processing unit (NPU), a 5G baseband processor, a wireless fidelity (WIFI) processor, and a memory controller. In some such examples, the controller alternatively or additionally is implemented in one or more of a microcontroller and software.

Another example provides a power management system for a computing device having a battery configured to power a processing unit, comprising a controller configured to receive a relative state-of-charge of the battery, and compute a current limit value based at least on the relative state-of-charge, a power channel including a first-stage regulator including a current limiter configured to dynamically limit, to the current limit value, a current flowing from the battery to the processing unit and resulting in a voltage droop on a first-stage output voltage, and a second-stage regulator configured to detect the voltage droop on the first-stage output voltage and lower a second-stage output voltage by an amount in response to the voltage droop meeting a droop threshold condition, the second-stage output voltage configured to power the processing unit. In some such examples, the second-stage regulator alternatively or additionally is configured to lower the second-stage output voltage by the amount for a duration of time and then raise the second-stage output voltage by the amount after the duration of time in response to the voltage droop on the first-stage output voltage meeting the droop threshold condition. In some such examples, the droop threshold condition alternatively or additionally is a first droop threshold condition, the amount is a first amount, and the second-stage regulator is configured to lower the second-stage output voltage by a second amount in response to the voltage droop on the first-stage output voltage meeting a second droop threshold condition. In some such examples, the power channel alternatively or additionally includes a second second-stage regulator configured to detect the voltage droop on the first-stage output voltage and lower a second second-stage output voltage by the amount in response to the voltage droop on the first-stage output voltage meeting the droop threshold condition. In some such examples, alternatively or additionally the power channel is a first power channel, the processing unit is a first processing unit, the current limit value is a first current limit value, the current is a first current, the controller alternatively or additionally is configured to compute a second current limit value based at least on the relative state-of-charge received, and comprising a second power channel including a second first-stage regulator including a current limiter configured to dynamically limit, to the second current limit value, a second current flowing from the battery to a second processing unit and resulting in a voltage droop on a second first-stage output voltage, and a second second-stage regulator configured to detect the voltage droop on the second first-stage output voltage and lower a second second-stage output voltage by an amount in response to the voltage droop on the second first-stage output voltage meeting a droop threshold condition, the second second-stage output voltage configured to power the second processing unit. In some such examples, the controller alternatively or additionally is configured to monitor a battery output voltage and adjust a performance parameter of the processing unit in response to the battery output voltage meeting a battery droop threshold condition.

Another example provides a method for controlling an electrical power flowing from a battery on a computing device, the method comprising estimating an available peak power envelope of the battery based at least on a relative state-of-charge of the battery, determining a current limit value based at least on the available peak power envelope, limiting, to the current limit value, a current flowing from the battery to a processing unit using a current limiter of a first-stage regulator and resulting in a voltage droop on a first-stage output voltage, detecting the voltage droop on the first-stage output voltage using a second-stage regulator, lowering a second-stage output voltage by an amount in response to the voltage droop on the first-stage output voltage meeting a droop threshold condition, and powering the processing unit using the second-stage output voltage. In some such examples, lowering the second-stage output voltage in response to the voltage droop on the first-stage output voltage meeting the droop threshold condition alternatively or additionally includes lowering the second-stage output voltage by the amount for a duration of time and then raising the second-stage output voltage by the amount after the duration of time. In some such examples, the method alternatively or additionally comprises monitoring a battery output voltage, adjusting a performance parameter of the processing unit in response to the battery output voltage meeting a battery droop threshold condition, and resetting the performance parameter of the processing unit in response to a power demand of the computing device meeting a system power condition. In some such examples, adjusting the performance parameter alternatively or additionally includes lowering an operational frequency of the processing unit. In some such examples, the method alternatively or additionally comprises counting a number of battery voltage droop events in a time period and determining when the battery droop threshold condition is met based at least on the number of battery voltage droop events counted. In some such examples, the method alternatively or additionally comprises determining an exponentially weighted moving average of threshold comparator output pulses and determining when the battery droop threshold condition is met based at least on the exponentially weighted moving average determined. In some such examples, the method alternatively or additionally comprises determining a second current limit value based at least on the available peak power envelope, limiting, to the second current limit value, a second current flowing from the battery to a second processing unit using a current limiter of a second first-stage regulator and resulting in a voltage droop on a second first-stage output voltage in response to the second current being over the second current limit value, detecting the voltage droop on the second first-stage output voltage using a second second-stage regulator, and lowering a second second-stage output voltage in response to the voltage droop on the second first-stage output voltage meeting the droop threshold condition.

As used herein, when an act is described as being taken in response to a condition it should be understood that the act may be predicated on other conditions as well as the described condition, except where described otherwise.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A power management system for a computing device having a battery configured to power a first processing unit and a second processing unit, comprising:
a controller configured to
receive a relative state-of-charge of the battery, and
compute a first current limit value and a second current limit value based at least on the relative state-of-charge;
a first power channel including a first first-stage regulator having a current limiter configured to dynamically limit, to the first current limit value, a first current flowing from the battery to the first processing unit; and
a second power channel including a second first-stage regulator having a current limiter configured to dynamically limit, to the second current limit value, a second current flowing from the battery to the second processing unit.

2. The power management system of claim 1, wherein the first first-stage regulator of the first power channel is a first-stage regulator configured to dynamically limit the first current and resulting in a voltage droop on a first-stage output voltage, and the first power channel further includes a second-stage regulator configured to detect the voltage droop on the first-stage output voltage and lower a second-stage output voltage by an amount in response to the voltage droop meeting a droop threshold condition, the second-stage output voltage configured to power the first processing unit.

3. The power management system of claim 2, wherein the second-stage regulator is configured to lower the second-stage output voltage by the amount for a duration of time and then raise the second-stage output voltage by the amount after the duration of time in response to the voltage droop on the first-stage output voltage meeting the droop threshold condition.

4. The power management system of claim 2, wherein the second-stage regulator is implemented in a power management integrated circuit (PMIC).

5. The power management system of claim 1, wherein the controller is configured to monitor a battery output voltage and adjust a performance parameter of the processing unit in response to the battery output voltage meeting a battery droop threshold condition.

6. The power management system of claim 1, wherein the processing unit is selected from the group consisting of a processor core, a central processing unit (CPU), a graphics processing unit (GPU), a neural processing unit (NPU), a 5G baseband processor, a wireless fidelity (WIFI) processor, and a memory controller.

7. The power management system of claim 1, wherein the controller is implemented in one or more of a microcontroller and software.

8. A power management system for a computing device having a battery configured to power a processing unit, comprising:
a controller configured to
receive a relative state-of-charge of the battery, and
compute a current limit value based at least on the relative state-of-charge;
a power channel including:
a first-stage regulator including a current limiter configured to dynamically limit, to the current limit value, a current flowing from the battery to the processing unit and resulting in a voltage droop on a first-stage output voltage, and
a second-stage regulator configured to detect the voltage droop on the first-stage output voltage and lower a second-stage output voltage by an amount in response to the voltage droop meeting a droop threshold condition, the second-stage output voltage configured to power the processing unit.

9. The power management system of claim 8, wherein the second-stage regulator is configured to lower the second-stage output voltage by the amount for a duration of time and then raise the second-stage output voltage by the amount after the duration of time in response to the voltage droop on the first-stage output voltage meeting the droop threshold condition.

10. The power management system of claim 8, wherein the droop threshold condition is a first droop threshold condition, the amount is a first amount, and the second-stage regulator is configured to lower the second-stage output voltage by a second amount in response to the voltage droop on the first-stage output voltage meeting a second droop threshold condition.

11. The power management system of claim 8, wherein the power channel further includes a second second-stage regulator configured to detect the voltage droop on the first-stage output voltage and lower a second second-stage output voltage by the amount in response to the voltage droop on the first-stage output voltage meeting the droop threshold condition.

12. The power management system of claim 8, wherein the power channel is a first power channel, the processing unit is a first processing unit, the current limit value is a first current limit value, the current is a first current, the controller further is configured to compute a second current limit value based at least on the relative state-of-charge received, and further comprising a second power channel including:
a second first-stage regulator including a current limiter configured to dynamically limit, to the second current limit value, a second current flowing from the battery to a second processing unit and resulting in a voltage droop on a second first-stage output voltage, and
a second second-stage regulator configured to detect the voltage droop on the second first-stage output voltage and lower a second second-stage output voltage by an amount in response to the voltage droop on the second first-stage output voltage meeting a droop threshold condition, the second second-stage output voltage configured to power the second processing unit.

13. The power management system of claim 8, wherein the controller is configured to monitor a battery output voltage and adjust a performance parameter of the processing unit in response to the battery output voltage meeting a battery droop threshold condition.

14. A method for controlling an electrical power flowing from a battery on a computing device, the method comprising:
estimating an available peak power envelope of the battery based at least on a relative state-of-charge of the battery;
determining a current limit value based at least on the available peak power envelope;
limiting, to the current limit value, a current flowing from the battery to a processing unit using a current limiter of a first-stage regulator and resulting in a voltage droop on a first-stage output voltage;
detecting the voltage droop on the first-stage output voltage using a second-stage regulator;
lowering a second-stage output voltage by an amount in response to the voltage droop on the first-stage output voltage meeting a droop threshold condition; and
powering the processing unit using the second-stage output voltage.

15. The method of claim 14, wherein lowering the second-stage output voltage in response to the voltage droop on the first-stage output voltage meeting the droop threshold condition includes lowering the second-stage output voltage by the amount for a duration of time and then raising the second-stage output voltage by the amount after the duration of time.

16. The method of claim 14, further comprising
monitoring a battery output voltage,
adjusting a performance parameter of the processing unit in response to the battery output voltage meeting a battery droop threshold condition, and
resetting the performance parameter of the processing unit in response to a power demand of the computing device meeting a system power condition.

17. The method of claim 16, wherein adjusting the performance parameter includes lowering an operational frequency of the processing unit.

18. The method of claim 16, further comprising counting a number of battery voltage droop events in a time period and determining when the battery droop threshold condition is met based at least on the number of battery voltage droop events counted.

19. The method of claim 16, further comprising determining an exponentially weighted moving average of threshold comparator output pulses and determining when the battery droop threshold condition is met based at least on the exponentially weighted moving average determined.

20. The method of claim 14, further comprising:
determining a second current limit value based at least on the available peak power envelope,
limiting, to the second current limit value, a second current flowing from the battery to a second processing unit using a current limiter of a second first-stage regulator and resulting in a voltage droop on a second first-stage output voltage in response to the second current being over the second current limit value,
detecting the voltage droop on the second first-stage output voltage using a second second-stage regulator, and
lowering a second second-stage output voltage in response to the voltage droop on the second first-stage output voltage meeting the droop threshold condition.
